(19) United States
(12) Patent Application Publication
(10) Pub. No.: US 2015/0324100 A1
(43) Pub. Date: Nov. 12, 2015

(54) Preview Reticule To Manipulate Coloration In A User Interface

(71) Applicant: Tictoc Planet, Inc., San Francisco, CA (US)

(72) Inventors: Marc B.D. Greenberg, Oakland, CA (US); Mintak Son, San Francisco, CA (US); Jinhwa Jang, Seongnam-si (KR); Heeyong Kim, Seongnam-si (KR)

(73) Assignee: Tictoc Planet, Inc., San Francisco, CA (US)

(21) Appl. No.: 14/273,391

(22) Filed: May 8, 2014

(51) Int. Cl. G06F 3/0484

(52) U.S. Cl. CPC G06F 3/04847; G06F 3/04842

(57) ABSTRACT

A client device displays user interface elements on a display device such as a screen. At least some of the user interface elements have an associated coloration. An input device of the client device detects a user input intended to modify the coloration of a user interface element. The user interface displays a preview reticule in response to an initial user input and moves the displayed preview reticule in response to a transitional user input. The preview reticule displays a spatial arrangement of colorations for selection. The selected coloration corresponds to a coloration at a predefined point in the preview reticule. A terminal user input completes selection of the coloration and hides the preview reticule. The interface may then display the user interface element in the selected coloration. The interface may also display the user interface element transitioning in coloration as the preview reticule moves.

### BACKGROUND OF THE INVENTION

1. Field of the Invention

This disclosure relates generally to user interfaces of computing device applications, and more particularly to text display in user interfaces of mobile applications.

2. Description of the Related Art

Mobile devices often include an interface for composing, sending, and receiving textual messages. These interfaces are typically designed to send messages through protocols similar to the Short Message Service (SMS) protocol, which sends textual messages in standardized data packets. The SMS protocol allocates 1120 bits to the text content of a message, so the message may contain between 70 and 160 characters depending on the alphabet used. This compact data transfer protocol does not include metadata for formatting the enclosed text or allow for images or other media. Due to the constraints of SMS and similar protocols, texting interfaces typically provide limited composition functionality limited mainly to inputting letters, numerals, and punctuation. More recently, upgrades to wireless communications infrastructure have enabled message transfer through more verbose protocols than SMS. For example, these protocols support a broader range of characters (e.g., emoticons, emojis) and may also support media messages (e.g., Multimedia Messaging Service, device-specific protocols). Nonetheless, textual message interfaces on mobile devices maintain much of the same limited functionality from their SMS-influenced origin.

### SUMMARY

Embodiments relate to manipulating coloration in a user interface. A client device receives user inputs to manipulate coloration of a user interface element. For example, the user inputs include an initial user input, a transitional user input, and a terminal user input. The client device displays a preview reticule in response to the initial user input, moves the preview reticule in response to the transitional user input, and hides the preview reticule in response to the terminal user input. The preview reticule displays a spatial arrangement of colorations in a continuous area overlaying the user interface. The displayed spatial arrangement varies with the area on which the preview reticule is overlaid based on an underlying spatial arrangement of colorations. The client device displays the user interface element in the coloration corresponding to a predefined point (e.g., the center) of the preview reticule when the transitional user input is received. The client device may update the coloration of the user interface element, the displayed spatial arrangement in the preview reticule, and the area on which the preview reticule is overlaid in response to multiple transitional user inputs.

In one embodiment, the user interface is implemented on a client device. The client device includes a memory for storing instructions for a composer interface; additionally, the client device includes a processor for executing the instructions for the composer interface. The composer interface may also include a display device for displaying the composer interface and an input device for receiving user inputs and input message content (or other user interface elements). The client device may also include a network interface device for transmitting (e.g., sending and/or receiving) messages.

In one embodiment, the composer interface encodes message content and coloration for that message content into a message and transmits the message to another client device. The other client device can decode the message content and its coloration from the transmitted message. The other client device may display message content based on coloration.

In one embodiment, available colorations available for selection include colors, patterns, color gradients, and textures. The spatial arrangement of colorations may include a gradient of colors varying over the spatial arrangement or a pattern having properties varying over the spatial arrangement. The spatial arrangement may include a number of discrete regions each representing a coloration or a different spatial arrangement of colorations.

### BRIEF DESCRIPTION OF THE DRAWINGS

The file of this patent or application contains at least one drawing executed in color. Copies of this patent or patent application publication with color drawings will be provided by the Office upon request and payment of the necessary fee.

The teachings of the embodiments can be readily understood by considering the following detailed description in conjunction with the accompanying drawings.

FIG. 1 is a block diagram illustrating an environment for communicating between client devices, according to an embodiment.

FIG. 2A is a block diagram illustrating components of an example client device, according to an embodiment.

FIG. 2B is a block diagram illustrating modules on a memory of the client device, according to an embodiment.

FIG. 3A, FIG. 3B, and FIG. 3C illustrate a preview reticule in an example interface for manipulating background coloration in messages, according to an embodiment.

FIG. 4A, FIG. 4B, and FIG. 4C illustrate a preview reticule in an example interface for manipulating the coloration of message content, according to an embodiment.

FIG. 5 is a flow chart illustrating an example process for manipulating color of a user interface element with visual feedback through a color preview reticule, according to an embodiment.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of the disclosure.

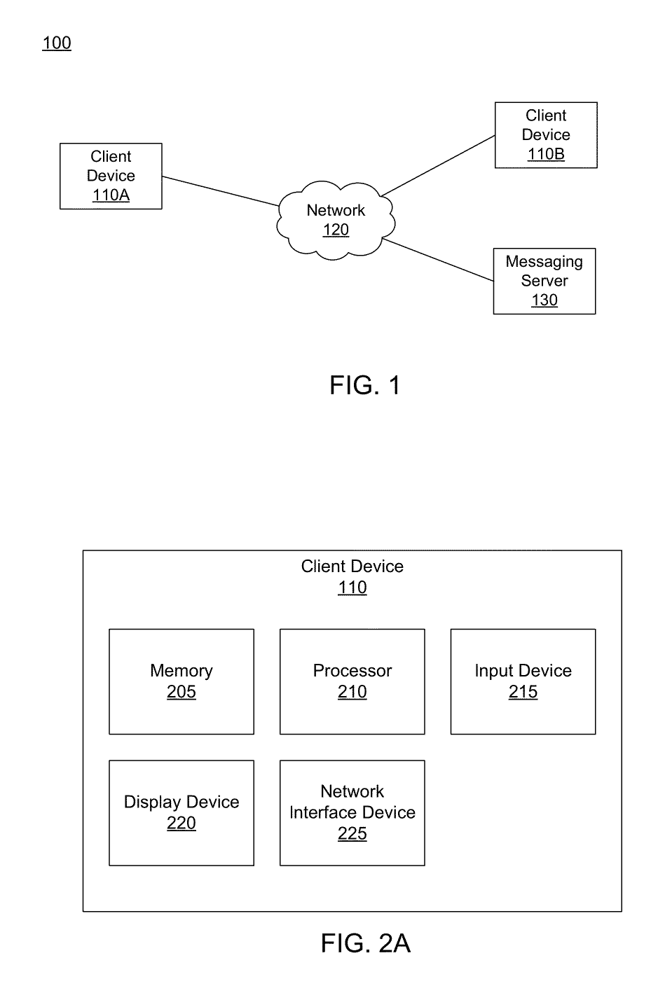

FIG. 1 is a block diagram illustrating an environment 100 for communicating between client devices 110A and 110B (hereinafter referred collectively as “the client devices 110”), according to an embodiment. The environment 100 includes entities such as client devices 110A and 110B, a network 120, and a messaging server 130. Users compose, send, and view messages using their client devices 110A and 110B. The environment 100 may include additional client devices (e.g., exchanging messages among a group). The client devices 110A and 110B may optionally include functionality for encrypting sent messages and decrypting received messages.

The client devices 110A and 110B may be mobile devices (e.g., smartphones, smart watches, wearable devices) or tablets, but they may also be other computing devices (e.g., a laptop, a desktop, and a smart television).

In one embodiment, the messaging server 130 receives a message sent by a client device 110A via the network 120 and routes the message to client device 110B via the network 120. The received message may include routing metadata (e.g., a user identifier, a phone number, an email address). The received messages may be encrypted, and the messaging server 130 may at least partially decrypt received messages to determine the message's one or more recipients. The messaging server 130 may push the received message to the client device 110B associated with the routing metadata, or the messaging server may send the received message to client device 110B in response to a device request for received messages. In other embodiments, messages may be sent directly between client devices 110A and 110B in a peer-to-peer configuration without using the messaging server 130 to route the messages.

The messaging server 130 is generally implemented on a computing device (e.g., a server) having a processor and a non-transitory, computer-readable storage medium. The processor executes instructions (e.g., computer program code) to perform functionality including message routing. The storage medium may also store messages, which may be deleted after delivery (or a threshold time thereafter). The messaging server 130 may include multiple computing devices (e.g., a server farm, a geographically dispersed content delivery network, a cloud-based system).

The network 120 enables communication among the entities connected to it through one or more local-area networks and/or wide-area networks. In one embodiment, the network 120 is the Internet and uses standard wired and/or wireless communications technologies and/or protocols. The network 120 may include links using technologies such as 802.11, worldwide interoperability for microwave access (WiMAX), long term evolution (LTE), or 4G. The data exchanged over the network 120 may be represented using various technologies and/or formats and may be encrypted. Although a single network 120 is illustrated, the network 120 may include multiple networks or sub-networks connecting the entities of the environment 100.

### Example Architecture of Client Device

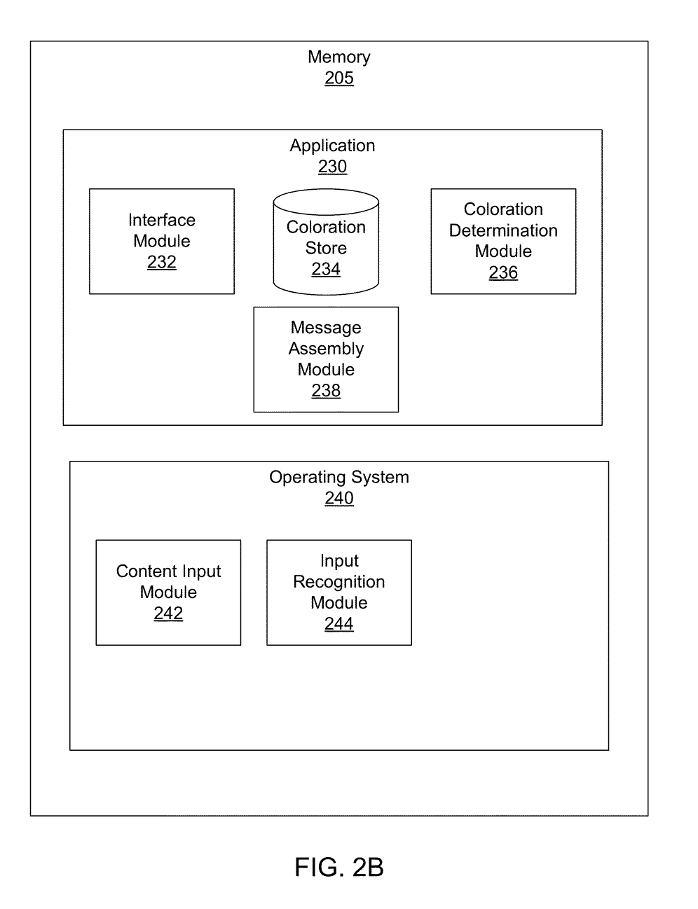

FIG. 2A is a block diagram illustrating components of an example client device 110, according to an embodiment. The example client device 110 may include, among other components, a memory 205, a processor 210, an input device 215, a display device 220, and a network interface device 225. The client device 110 may include other components not illustrated in FIG. 2A such as speakers and sensors.

The memory 205 stores instructions for execution by the processor 210. The memory 205 includes any non-transitory, computer-readable storage media capable of storing instructions. In one embodiment, the instructions include functionality of a messaging application and a device operating system. Example embodiments of memory 205 include semiconductor memory devices (e.g., electrically erasable programmable memory (EEPROM), random access memory (RAM)), flash memory devices, magnetic disks such as internal hard disks and removable discs, and optical discs such as CD-ROM or DVD discs. The instructions stored in the memory 205 are described below in detail with reference to FIG. 2B.

The processor 210 is hardware capable of executing computer instructions. The processor 210 may be coupled to the memory 205, the input device 215, the display device 220, and the network interface device 225. Example processors 210 include a microprocessor, a central processing unit (CPU), a graphic processing unit (GPU), a digital signal processor (DSP), a field-programmable gate array (FPGA), a programmable logic device (PLD), and an application-specific integrated circuit (ASIC). The processor 210 may include one or more cores, or the client device may include multiple processors 210 for concurrent execution of parallel threads of instructions.

The input device 215 enables communication with a user for receiving inputs related to message content (e.g., text, images, videos, audio, animations) as well as inputs to format or arrange message content. Example input devices 215 include a touchscreen, a keyboard integrated into the client device 110, a microphone for processing voice commands, or a physically separate but communicatively coupled device such as a wireless keyboard, a pointing device such as a mouse, or a motion-sensing device that detects gesticulations. In one embodiment, the input device 215 is a touchscreen capable of sensing example gestures including taps, double-taps, pinches or stretches between at least two points of contact, swiping motions (e.g. swipe gestures, scroll gestures) with one or more points of contact, and rotational motions about a point between two or more points of contact.

The display device 220 graphically displays interfaces of the client device 110 for viewing, composing, or sending messages. Example display devices 220 include a screen integrated with the client device 110 or a physically separate but communicatively coupled display device (e.g., a monitor, a television, a projector, a head-mounted display). Alternative or additional display devices 215 include other display technologies (e.g., holographic displays, tactile displays) or auditory displays (e.g., speakers or headphones that recite a received message). The display device 220 and the input device 215 may be integrated, for example, in a touchscreen.

The network interface device 225 may be hardware, software, firmware, or a combination thereof for connecting the client device 110 to the network 120. Example interface devices 225 include antennas (e.g., for cellular, WiFi, or Bluetooth communication) or ports that interface with a USB (Universal Serial Bus) cable or flash drive, or a HDMI (high-definition multimedia interface) cable as well as circuits coupled to these components for processing signals to be sent or received via these components. The interface device 225 may optionally communicatively couple the client device 110 to a separate input device 215 and/or display device 220.

FIG. 2B is a block diagram illustrating modules of an example application 230 and an example operating system 240 on the memory 205 of the example client device 110, according to an embodiment. The application 230 provides functionality for composing, viewing, and sending messages and includes an interface module 232, a coloration store 234, a coloration determination module 236, and a message assembly module 238. The application 230 may include additional modules not illustrated (e.g., for handling messages including images, audio, or video; for encrypting and decrypting messages).

The operating system 240 manages resources available on the client device 110. Applications access the resources of the client device 110 through the operating system 240. The operating system 240 may include, among other components, a content input module 242, and a input recognition module 244. The operating system 240 may include additional modules not illustrated (e.g., modules for interfacing with an audio output device or a display device 220, modules for low-level tasks such as memory management).

### Composing and Viewing Messages

The content input module 242 recognizes inputs received through the input device 215 and converts the received inputs to user interface elements for display by the interface module 232. For example, the content input module 242 maps signals from a keyboard input device to characters of text. In one embodiment where the input device 215 is a touch screen, the content input module 242 may include instructions for displaying a virtual keyboard interface to receive textual inputs. A user may select a region of the virtual keyboard on the touch screen that corresponds to a character to input that character. The content input module 242 resolves the selection of the character and indicates the selected character to the interface module 232. The content input module 242 may interpret inputs that correspond to multiple characters (e.g., using a swipe gesture across a touch screen keyboard to input several characters, where the beginning, end, and corners of the swipe gesture correspond to the input characters). The content input module 242 may provide for other input mechanisms such as speech-to-text processing or transferring content from another source (e.g., a copy-and-paste functionality). As another example, the content input module 242 creates images based on inputs from the input device 215 (e.g., for a doodling or a sketching application).

The interface module 232 provides a visual interface for composing messages as well as for viewing sent and received messages. In one embodiment, the interface module 232 displays message content entered by a user (such as text) in a composing region and provides for selection of one or more message recipients. The interface module 232 displays input message content (or other user interface elements) in a composing region of the interface. More broadly, the interface module 232 provides for display of one or more user interface elements, which include message content and other text, images (e.g., photos, icons), animations, videos, or any other element displayable through the display device 220. User interface elements may have a coloration and typically display other information besides coloration (e.g., text, an image, an interface element boundary). The interface module 232 may include a formatting functionality to vary the coloration of user interface elements (e.g., background color, text color, image tint). For example, in response to a user input received through the input device 215, the interface module 232 displays message contents of a composed, but unsent, message in different colorations based on coloration information retrieved from the coloration store 234. The interface module 232 may display the message content of a received message in a similar coloration to the coloration selected by a user of a sending client device. However, differences between display devices 220 on client devices 110 may slightly alter the displayed coloration of message content in a message sent between these client devices 110.

To display message content in one embodiment, the interface module 232 receives input message content such as text from the content input module 242 (for a composed but unsent message) or from a decoded message in the application 230. To display the message content in the intended coloration, the interface module 232 retrieves coloration data representing the coloration from the coloration store 234. For a received or sent message, the coloration may be decoded from coloration identifiers in formatting information incorporated in the message. For message content in a composed but unsent message, the coloration may be received from the coloration determination module 236. In either case, the interface module 232 may include a default coloration for use when the user has not selected a coloration for a user interface element. For example, the default coloration for a background user interface element is the color white, and the default coloration for a text user interface element is the color black.

The coloration store 234 includes a variety of colorations for display by the interface module 232. Coloration refers to a visual arrangement of one or more colors. Example colorations include a solid color, a texture, a pattern, or a gradient. A pattern is a spatially recurring figure in two or more colors. The spatial repetition follows one or more parameters that control orientation and frequency of repetition. A color gradient is a coloration having position-dependent colors and may be based on a mapping between a color space and spatial position.

The coloration store 234 also includes an underlying spatial arrangement of the entirety of colorations used by the interface module 232 to display the preview reticule. This underlying spatial arrangement may also be referred to herein as the “spatial arrangement of the entirety of colorations.” In one embodiment, the preview reticule displays a subset of the underlying spatial arrangement of colorations based on the position of the preview reticule. If the preview reticule moves, then the preview reticule displays another subset of colorations from the underlying spatial arrangement of the entire colorations. The underlying spatial arrangement may include a layout of discrete regions each corresponding to a different coloration. For example, the underlying spatial arrangement is a vertically striped rainbow of colors, or a patchwork of available patterns for selection. The underlying spatial arrangement may also be an apparently continuous layout of colors such as a color gradient. For example, the gradient displays the YUV color space at a constant luma (Y), so the chrominance (U and V) components vary across perpendicular spatial axes. The underlying spatial arrangement may display a pattern having a range of position-dependent parameters. For an example two-color stripe pattern, the spatial arrangement may show the stripe pattern in varying stripe thicknesses across a first screen dimension and in varying stripe frequencies across a second dimension.

As another example, the underlying spatial arrangement of coloration contains a color gradient based on the RGB space. The color gradient may be derived by projecting the RGB (Red Green Blue) space onto a two dimensional plane, stretching the projection into a rectangular configuration, and adding saturation and lightness in some regions. In addition to a region containing the modified RGB color gradient, the underlying spatial arrangement contains an adjacent region containing a grayscale gradient of colors.

As an alternative to storing the underlying spatial arrangement, the coloration store 234 may contain instructions for generating the underlying spatial arrangement. The interface module 232 displays spatial arrangements based on these instructions and based on the position of the area occupied by the preview reticule displaying the spatial arrangement of coloration. The instructions specify how to generate a color gradient of colorations based on position within the screen. For example, the instructions indicate hue and saturation as a function of vertical position on the screen as well as lightness as a function of horizontal position on the screen.

### Coloration Determination

The input recognition module 244 recognizes inputs corresponding to a location on the display device 220. A user navigates the interface and controls formatting of user interface elements using one or more user inputs. To select or modify coloration of a user interface, element, a user makes inputs through the input device 215. In one embodiment, operations to select coloration include an initial user input that initiates coloration selection, a transitional user input that selects the coloration, and a terminal user input that terminates selection of coloration. The input recognition module 244 recognizes locations associated with the initial, transitional, and terminal user inputs, which the coloration determination module 236 uses to determine the coloration. The transitional user input may be associated with multiple locations between a location of the initial user input and a location of the terminal user input. For example, the input recognition module 244 recognizes locations that a swipe gesture input contacts on the screen over time associated with a swipe gesture input is associated with the set of locations the swipe gesture contacts on the screen over time. In the example case of a click-and-drag input, the input recognition module 244 recognizes locations between the location of the “click” (the initial user input) and the last location of the “drag” (the transitional user input). In an alternative embodiment, the transitional user input may be omitted.

The input recognition module 244 may optionally detect a configuration user input to initiate a state for modifying the coloration of a user interface element. For example, this configuration user input comprises selecting a color palette icon displayed in the user interface. The configuration input may also include an input to select a user interface element for coloration modification. For example, the input recognition module 244 recognizes a user input at the same location of a displayed user interface element to select that user interface element for modification.

Alternatively or additionally, the input recognition module 244 determines whether a user input is intended to modify coloration based on the location associated with the initial user input. If this initial location is within a composing region associated with the coloration of a user interface element, then the initial user input and subsequent inputs are treated as inputs to modify the coloration. The composing region is a region containing user interface elements that may be modified. In the context of a messaging application, the composing region contains unsent text and other message content.

In one embodiment, the input recognition module 244 recognizes user inputs made with a gesture object on or substantially close to a gesture-sensing surface (e.g., a touchscreen or other screen, a touch-sensitive whiteboard) that combines the functionality of the input device 215 and the display device 220. A gesture object is an object used to interact with a gesture-sensing surface. Example gesture objects include a finger, a stylus, or another writing implement configured to interact with a proximate gesture-sensing surface. The input recognition module 244 recognizes gestures, which begin with the gesture object contacting the surface, corresponding to an initial user input. The gesture object then moves across the surface while maintaining contact with the surface, corresponding to a transitional user input. The gesture is complete when the gesture object detaches from the surface after moving across the screen, corresponding to a terminal user input. Generally, the gesture encompasses a single continuous contact between the surface and one or more gesture objects. A contact between the surface and the gesture object includes physical contact on or substantially close to the surface.

In one embodiment, the interface module 232 includes instructions for displaying a preview reticule that overlays a portion of the user interface. The preview reticule is a user interface element that displays a spatial arrangement of colorations to aid in selecting a coloration. In one embodiment, the preview reticule is a circle, but the preview reticule may appear as another shape (e.g., a rectangle, a ribbon, a spiral) overlaid over other displayed user interface elements. Generally, the preview reticule is a continuous, contained area displaying a spatial arrangement of colorations. The interface module 232 may display the preview reticule near the location of the initial user input. To select a coloration, a user makes a transitional user input. The interface module 232 may display the preview reticule moved to overlay a different area of the user interface based on the location of the transitional user input. In response to a terminal user input, the interface module 232 may hide the preview reticule from display.

The coloration determination module 236 selects a coloration to display using the locations determined by the input recognition module 244 as well as a spatial arrangement for display in the preview reticule. The coloration determination module 236 may also select a spatial arrangement for display in the preview reticule from the underlying spatial arrangement of entire colorations in the coloration store 234. In one embodiment, the coloration determination module 236 receives the location of the initial user input and selects a first spatial arrangement based on the location of the initial user input. The underlying spatial arrangement generally corresponds to the location of the user input. For example, if received initial user input is in the upper-left portion of the display device 220, then the spatial arrangement displayed in the preview reticule corresponds to an upper-left portion or the underlying spatial arrangement of colorations. The coloration determination module 236 instructs the interface module 232 to display the first spatial arrangement in the color preview reticule, which is overlaid over an area of the user interface nearby the location of the initial user input.

The coloration determination module 236 may receive a location of a transitional user input and select a second spatial arrangement from the underlying spatial arrangement of colorations based on the location of the transitional user input. This second spatial arrangement is selected using a positional mapping between the location of the transitional input and a portion of the underlying spatial arrangement, similar to mapping the initial user input to another portion of the underlying spatial arrangement to select the first spatial arrangement. The coloration determination module 236 instructs the interface module 232 to display the second spatial arrangement in the preview reticule in an area nearby the location of the transitional user input. Additionally, the coloration determination module 236 selects a coloration based on a coloration displayed at a predefined point (e.g., the center) of the preview reticule, and instructs the interface module 236 to display the user interface element in the selected coloration.

In one embodiment, the input recognition module 244, the coloration determination module 236, and the interface module 232 communicate substantially in real time to provide visual feedback for a user input to modify or select coloration. The input recognition module 244 recognizes multiple locations of the transitional user input over time. For each recognized location, the coloration determination module 236 selects an updated spatial arrangement, and the interface module 232 display the updated spatial arrangement in the preview reticule, which is overlaid in areas near the recognized locations. Additionally, the coloration determination module 236 determines an updated coloration for each recognized location based on the predetermined point in the preview reticule and the spatial arrangement for the recognized location. The interface module 232 displays the user interface element in the updated coloration for each recognized location.

For an example involving a touch screen, a user makes a swipe gesture across the screen. The color preview reticule is displayed near the initial point of contact for the swipe gesture and appears to follow the swipe gesture until the swipe gesture ends. As the color preview reticule moves across the screen, the displayed spatial arrangement progressively slides from the spatial arrangements corresponding to the location of initial user input to the spatial arrangement corresponding to the location of the terminal user input. Meanwhile, the user interface element takes on the colorations at the center of the preview reticule along its path. When the swipe gesture ends, the user interface element retains its last coloration.

When a user decides to send a message, the message assembly module 238 encodes message contents and the colorations (as determined by the configuration module 236) into a message. The assembled message may be represented in a standardized format that incorporates message metadata, message content, and message formatting. Message metadata may include times associated with the message (e.g., sent time, receipt time) or data used to route the message such as an indicator of the message protocol or unique identifiers (e.g., of the message sender, of the message recipient, of the message itself). Encoded message contents include the substantive content of the message, such as text, images, videos, audio, or animations. Lastly, the message formatting indicates formatting of message content, including coloration of message content such as the background, or the text, for example. Other message formatting information includes font size, font, other text formatting, and relative positions of message contents, for example. The network interface device 225 transmits the assembled message to the recipient's client device 110.

### Example User Interface

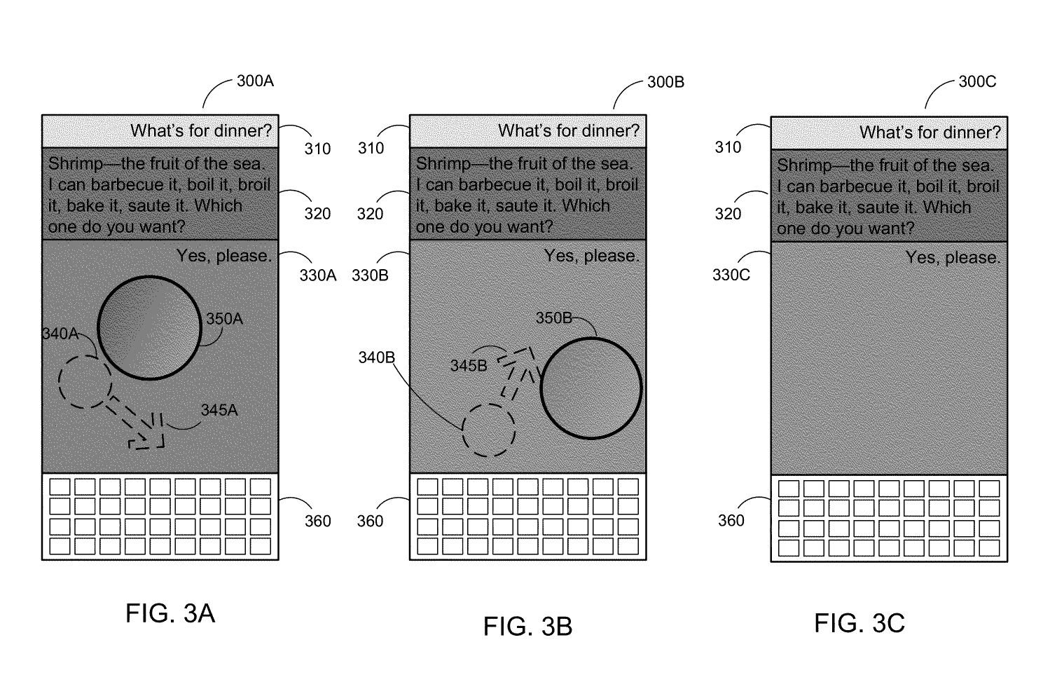

FIG. 3A, FIG. 3B, and FIG. 3C illustrate a preview reticule 350 in an example interface 300 for manipulating background coloration in messages, according to an embodiment. The interface includes a first message 310, a second message 320, and composed message 330, as well as a virtual keyboard 360 for inputting a textual input through the content input module 242. The background colorations of the first and second messages 310 and 320 are the colors yellow and red, respectively. FIG. 3A illustrates an initial interface 300A created by the interface module 232 in response to an initial user input 340A to select a coloration. The user makes an initial user input 340A at a first input location by pressing on the display device 220. In response to the initial user input 340A, the preview reticule 350A appears and displays a first spatial arrangement of colorations. The interface module 232 displays the composed message 330A with a background coloration selected based on the coloration at a predefined point (e.g., the center) of the preview reticule. The user makes a transitional user input 345A by making a swiping gesture against the screen from the first input location to a second input location.

FIG. 3B illustrates the interface 300B after receipt of the transitional user input 345A. In response to the transitional user input 345A, the background coloration of the composed message 330B has changed to a blue color, consistent with the first spatial arrangement of the preview reticule 350A and the direction of the transitional user input 345A to the second input location 340B. In addition, the preview reticule 350B displays a second spatial arrangement centered at the blue coloration of the background of the composed message 330B. The user maintains contact with the screen and makes an additional transitional user input 345B from the second input location 340B.

FIG. 3C illustrates the interface 300C after receipt of the additional transitional user input 345B. The background coloration of the composed message 330C has changed to a green color, consistent with the second spatial arrangement of the preview reticule 350B and the direction of the transitional user input 350B.

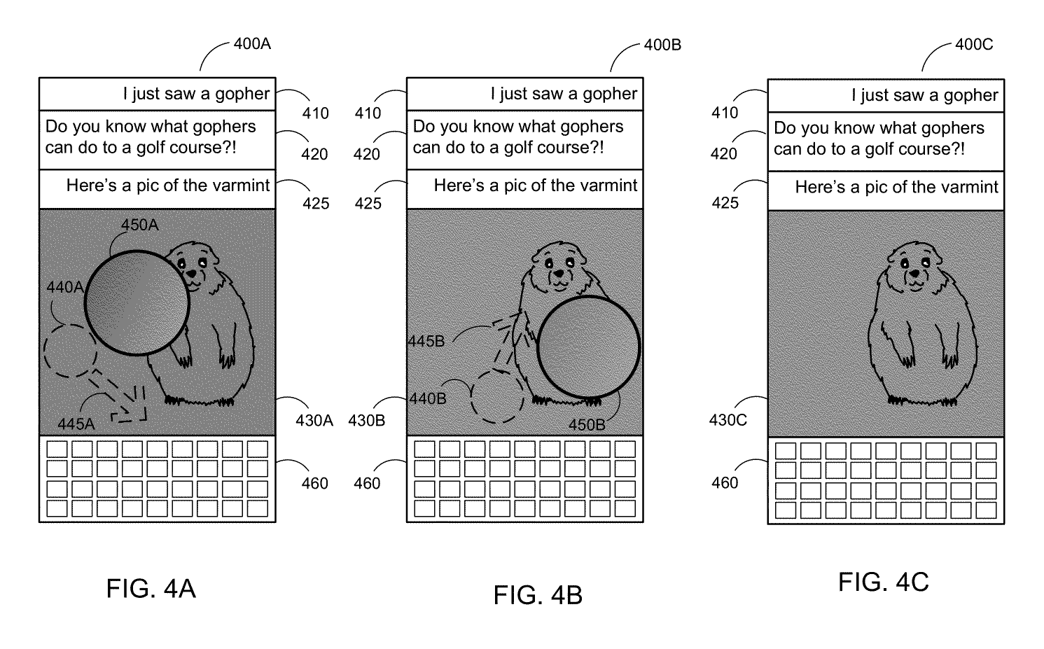

FIG. 4A, FIG. 4B, and FIG. 4C illustrate a preview reticule 450 in an example interface 400A for manipulating the coloration of message content, according to an embodiment. The interface includes a first message 410, a second message 420, a third message 425, and a composed message 430, as well as a virtual keyboard 460 for inputting a textual input through the content input module 242. The composed message 430 includes an image (message content). FIG. 4A illustrates an initial interface 400A created by the interface module 232 in response to an initial user input 440A to select a coloration to tint the image. The user makes an initial user input 440A at a first input location by pressing on the display device 220. In response to the initial user input 440A, the preview reticule 450A appears and displays a first spatial arrangement of colorations. The interface module 232 displays the composed message 430A with an image tint coloration selected based on the coloration at a predefined point (e.g., the center) of the preview reticule. The user makes a transitional user input 445A by making a swiping gesture against the screen from the first input location to a second input location.

FIG. 4B illustrates the interface 400B after receipt of the transitional user input 445A. In response to the transitional user input 445A, the tint coloration of the image in the composed message 430B has changed to a blue color, consistent with the first spatial arrangement of the preview reticule 450A and the direction of the transitional user input 445A to the second input location 440B. In addition, the preview reticule 450B displays a second spatial arrangement centered at the blue coloration of the composed message 430B. The user maintains contact with the screen and makes an additional transitional user input 445B from the second input location 440B.

FIG. 4C illustrates the interface 400C after receipt of the additional transitional user input 445B. The tint coloration of the image of the composed message 430C has changed to a green color, consistent with the second spatial arrangement of the preview reticule 450B and the direction of the transitional user input 450B.

### Process of Manipulating Coloration

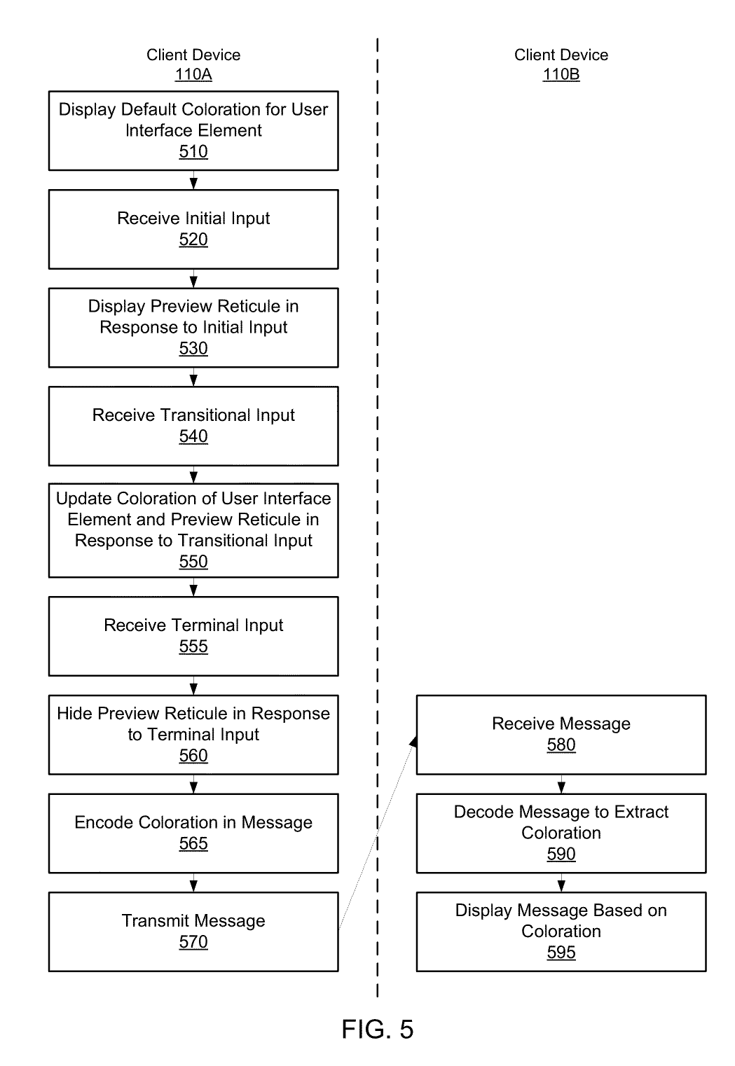

FIG. 5 is a flow chart illustrating an example process for manipulating color of a user interface element with visual feedback through a color preview reticule, according to an embodiment. The interface module 232 displays 510 (through the display device 220) a default coloration for a user interface element. The input recognition module 244 receives 520 an initial user input (e.g., a contact between a gesture object and the display device 220) at a first input location. In response to receiving the initial user input, the coloration determination module 236 selects a first spatial arrangement from the underlying spatial arrangement of colorations and retrieves the first spatial arrangement from the coloration store 234. The interface module 232 displays 530 the first spatial arrangement in a preview reticule at a first area of the user interface. The first spatial arrangement may be selected based on the first input location or the position of the first display area of the preview reticule.

The input recognition module 244 receives 540 a transitional user input (e.g., a sliding motion with the gesture object) to a second input location. In response to the transitional user input, the coloration determination module 236 selects a second spatial arrangement from the underlying spatial arrangement of colorations and retrieves the second spatial arrangement from the coloration store 234. The coloration determination module 236 also selects a coloration for the user interface element based on a coloration at a predefined point in the preview reticule displaying the second spatial arrangement. The interface module 232 updates 550 the coloration of the user interface element and updates 550 the preview reticule to display the second spatial arrangement in a second area of the user interface. The second spatial arrangement may be selected based on the second input location or the position of the second display area of the preview reticule.

The input recognition module 244 receives 555 a terminal user input (e.g., the gesture object detaches from the display device 220). In response to detecting the terminal user input, the interface module 232 hides 560 the preview reticule.

The message assembly module 238 encodes 565 the message content and the coloration into a message, and the client device 110A transmits 570 the message via the network interface device 225. Another client device 110B receives 580 the message (e.g., via the network interface device 225) and decodes 590 the message to extract the message content and its coloration (e.g., based on the protocol of the message assembly module 238). The other client device 110B displays 595 (e.g., through an interface module 232) the message content of the message based on its coloration.

In an alternative implementation outside of a messaging context, any user interface element may replace the message content, and the example process may end after updating 550 the coloration of the user interface element and/or of the preview reticule without creating and transmitting a message. For example, the client device 110A waits for additional content inputs or gestures to directly manipulate the coloration of the displayed user interface elements. This alternative implementation includes applications such as word processing, editing portions of electronic doodles, and editing portions of photographs, for example. In this alternative implementation, the client device 110B is optional.

The disclosed embodiments beneficially enable convenient manipulation of the coloration of user interface elements displayed on a client device. Manipulating coloration message content of sent messages provides a more nuanced form of communication because users may convey emotions or other subtleties through choice of coloration. The process of manipulating coloration through multiple gestures (e.g., selecting a user interface element, then selecting a color through a drop down menu) deters coloration manipulation in hastily composed messages. The disclosed embodiments may be implemented without dedicated buttons (or other regions of the display device 215) for manipulating coloration, which may clutter the user interface on a small display devices 215. Overall, direct coloration manipulation enhances the user experience in a messaging or other context that provides for display of colored user interface elements.

The preview reticule advantageously provides for a convenient and intuitive means for altering the coloration of message content or other user interface elements. By displaying the preview reticule in response to an initial user input and hiding the preview reticule after a terminal user input, the client device 110 displays the preview reticule when it is relevant to more efficiently use screen space. Displaying the spatial arrangement of coloration in the preview reticule provides for predictable selection of coloration. Continuously updating the spatial arrangement of colorations in the preview reticule in response to transitional user inputs provides for continuous feedback over the course of the gesture input. The underlying spatial arrangement of colorations may include colors in a color gradient, which provides numerous options for users to express emotions.

While particular embodiments and applications of the present invention have been illustrated and described, it is to be understood that the disclosure is not limited to the precise construction and components disclosed herein. Various modifications, changes and variations may be made in the arrangement, operation and details of the method and apparatus of the present disclosure without departing from the spirit and scope of the disclosure as described herein.

What is claimed is:

1. A method for selecting coloration of a user interface element on a screen of a computing device, the method comprising:
displaying a user interface including a user interface element on the screen;
detecting an initial user input to initiate an operation to select coloration of the user interface element;
displaying a preview reticule overlaid over the user interface at a first area of the screen in response to receiving the initial user input, the preview reticule defining a continuous and confined area for displaying a first spatial arrangement of coloration representing a first subset of colorations available for selection;
displaying portions of the user interface element in areas of the screen other than the first area, the one or more user interface elements representing information other than the colorations available for selection;
detecting a transitional user input representing moving of the preview reticule to a second area of the screen;
displaying the preview reticule at the second area of the screen, the preview reticule overlaid over the user interface at the second area displaying a second spatial arrangement of coloration representing a second subset of coloration available for selection, responsive to receiving the transitional user input; and
selecting coloration at a predetermined location of the preview reticule at the second area responsive to detecting a terminal user input representing termination of the operation to select the coloration of the user interface element.

2. The method of claim 1, wherein the initial user input represents touching of a first input location in a predefined region of the screen by a gesture object.

3. The method of claim 2, wherein the transitional user input comprises the gesture object moving across the screen from the first input location to a second input location while remaining in contact with the screen.

4. The method of claim 3, wherein the displayed preview reticule is overlaid in different locations on the screen between the first area and the second area in response to the gesture object moving across the screen.

5. The method of claim 3, wherein the first spatial arrangement of coloration representing the first subset of colorations is displayed in the preview reticule based on the first input location.

6. The method of claim 5, further comprising displaying a transition of coloration of the user interface element as the preview reticule moves from the first area to the second area.

7. The method of claim 4, wherein the second spatial arrangement of coloration representing the second subset of colorations is displayed in the preview reticule based on the second input location.

8. The method of claim 1, wherein the colorations available for selection comprise at least one of: colors, patterns, color gradients, and textures.

9. The method of claim 1, wherein the first spatial arrangement and the second spatial arrangement are regions representing selected regions of a spatial arrangement of entire colorations available for selection, the first spatial arrangement selected from the spatial arrangement of the entire colorations based on the first area and the second spatial arrangement selected from the spatial arrangement of the entire colorations based on the second area.

10. The method of claim 9, wherein the spatial arrangement of the entire colorations comprises a plurality of colors displayed in a color gradient arranging the plurality of colors based on a mapping of a color space to position within the spatial arrangement of the entire colorations.

11. The method of claim 9, wherein the spatial arrangement of the entire colorations comprises a plurality of colorations each in a discrete region of the spatial arrangement of the entire colorations.

12. The method of claim 1, wherein the user interface element is message content, the method further comprising:
encoding the user interface element and the selected coloration into a message; and
transmitting the message including the user interface element and the selected coloration to another computing device configured to display the user interface element in the selected coloration.

13. A non-transitory computer-readable storage medium comprising instructions for selecting coloration of a user interface element on a screen of a computing device, the instructions when executed by a processor cause the processor to:
instruct the screen to display a user interface including a user interface element on the screen;
receive an initial user input to initiate an operation to select coloration of the user interface element;
instruct the screen to display a preview reticule overlaid over the user interface at a first area of the screen in response to receiving the initial user input, the preview reticule defining a continuous and confined area for displaying a first spatial arrangement of coloration representing a first subset of colorations available for selection;
instruct the screen to display portions of the user interface element in areas of the screen other than the first area, the one or more user interface elements representing information other than the colorations available for selection;
receive a transitional user input representing moving of the preview reticule to a second area of the screen;
instruct the screen to display the preview reticule at the second area of the screen, the preview reticule at the second area displaying a second spatial arrangement of coloration representing a second subset of coloration available for selection, responsive to receiving the transitional user input; and
select coloration at a predetermined location of the preview reticule at the second area responsive to receiving a terminal user input representing termination of the operation to select the coloration of the user interface element.

14. The storage medium of claim 13, wherein the instructions further comprise instructions to instruct the screen to display the user interface element in the selected coloration.

15. The storage medium of claim 13, wherein the initial user input represents touching of a first input location in a predefined region of the screen by a gesture object.

16. The storage medium of claim 15, wherein the transitional user input comprises the gesture object moving across the screen from the first input location to a second input location while remaining in contact with the screen.

17. The storage medium of claim 13, wherein the instructions further comprise instructions to:
encode the user interface element and the selected coloration into a message; and
transmit the message including the user interface element and the selected coloration to another computing device configured to display the user interface element in the selected coloration.

18. A system for modifying color of a user interface element, the system comprising:
a processor;
a display device configured to display user interface elements;
an input recognition module configured to detect inputs including:
an initial user input to initiate an operation to select coloration of the user interface element,
a transitional user input representing moving of a preview reticule to a second area of the screen, and
a terminal user input representing termination of the operation to select the coloration of the user interface element;
an interface module causing the screen to:
display a user interface including a user interface element on the screen;
display the preview reticule overlaid over the user interface at a first area of the screen in response to receiving the initial user input, the preview reticule defining a continuous and confined area for displaying a first spatial arrangement of coloration representing a first subset of colorations available for selection, and
display the preview reticule at the second area of the screen, the preview reticule at the second area displaying a second spatial arrangement of coloration representing a second subset of coloration available for selection, responsive to receiving the transitional user input;
display portions of the user interface element in areas of the screen other than the first area, the one or more user interface elements representing information other than the colorations available for selection; and
a coloration determination module configured to select coloration at a predetermined location of the preview reticule at the second area responsive to receiving the terminal user input.

19. The system of claim 18, wherein the interface module further causes the screen to display the user interface element in the selected coloration.

20. The system of claim 18, further comprising:
a message assembly module configured to encode the user interface element and the selected coloration into a message; and
a network interface device configured to transmit the message including the encoded user interface element and the selected coloration to another computing device to display the user interface element in the selected coloration.
